(19) United States
(12) Patent Application Publication
(10) Pub. No.: US 2023/0083481 A1
(43) Pub. Date: Mar. 16, 2023

(54) SYSTEM AND METHOD FOR USER INTERFACE MANAGEMENT TO PROVIDE PERSONALIZED DIETARY RECOMMENDATIONS AND TRACKING

(71) Applicant: Capriotti Preventive Health Care, LLC, Doylestown, PA (US)

(72) Inventors: Theresa Capriotti, Doylestown, PA (US); Catherine Capriotti, Doylestown, PA (US); Nicholas Langan, Tabernacle, NJ (US); Robert Rotyliano, Medford, NJ (US)

(21) Appl. No.: 17/944,786

(22) Filed: Sep. 14, 2022

Related U.S. Application Data
(60) Provisional application No. 63/243,858, filed on Sep. 14, 2021.

(51) Int. Cl. G06Q 50/12; G06Q 30/06

(52) U.S. Cl. CPC G06Q 50/12; G06Q 30/0631; G06Q 30/0641; G06Q 40/02

(57) ABSTRACT

A computerized system for user interface management displays guidance relevant to a person's selection of healthier food items choices. The system tracks dietary needs on a per-user basis, references nutritional information for standardized restaurant menu items, and makes personalized menu item recommendations based on each user's dietary needs and preferences. The system may track past consumption and associated nutritional information and consider such past consumption in making personalized recommendations. Geolocation/location-aware functionality may be used to identify nearby restaurants and associated restaurant menu items in support of making of suitable menu item recommendations according to each user's dietary needs and preferences. The user's dietary profile can be used to identify recommended menu items according to known associate nutrients, to provide the user with an easily-accessible, actionable plan for eating healthier food items consistent with the user's dietary needs and preferences, even for so-called “fast food” restaurants.

### CROSS-REFERENCE TO RELATED APPLICATION

This application claims the benefit of priority under 35 U.S.C. § 119(e) of U.S. Provisional Patent Application No. 63/243,858 filed, Sep. 14, 2021, the entire disclosure of which is hereby incorporated herein by reference.

### FIELD OF THE INVENTION

The present invention relates generally to controlling a user interface of a computerized system to provide personalized dietary recommendations and tracking, and more particularly to providing a device and graphical user interface that displays information and guidance that is relevant to a person's selection of menu items from nearby restaurants that are healthier generally and/or in relation to each person's particular dietary needs and preferences, in view of relevant past food consumption.

### DISCUSSION OF RELATED ART

Despite consumer awareness of the importance of diet in maintaining good health, a large proportion of Americans rely on fast food or take-out food from their local restaurants. Studies show 37% of Americans eat at least one meal daily from a fast-food outlet or restaurant (2017-2018 National Health and Nutrition Examination Survey (NHANES); CDC, 2020). Studies also show that 80% of consumers use nutrition to manage health disorders and choose foods accordingly (The Nielsen Group, 2014; The Nielsen Group, 2015). Studies of consumer interest in nutrition indicates that 1 in 3 supermarket customers read product nutrition labels prior to purchasing a grocery item. The sector of the population that are most interested in their nutritional selections include millennials (approximately ages 25 to 40) and seniors (age 65+) (The Nielsen Group 2015).

Obesity, hypertension, hypercholesterolemia, cardiovascular disease, diabetes mellitus, and fatty liver disease are common health problems in Americans (American Heart Association, 2021, American Diabetes Association, 2021, American Liver Foundation, 2021, Raynor & Champagne, 2018). Dietary and nutritional choices are key aspects the management of each one of these disorders. Obesity, hypertension, metabolic syndrome, hyperlipidemia, cardiovascular disease, diabetes, and fatty liver disease are all disorders having a dietary component in the treatment plan. Many physicians and nutritionists will hand the patient a document that lists foods to avoid or give them a list of specific numerical limits of certain nutrients per day (e.g., 40 gms carbohydrates, 30 gms fats, and 2000 mg sodium). These are not easily understood concepts and these restrictions are difficult to implement for the average consumer. Many patients have difficulties with understanding and applying, and thus complying, the with necessary guidelines

Further, many people do not have time in their highly scheduled life to prepare the right foods in the correct way for proper nutrition. Working people commonly choose prepared foods to take out-most dine out or take out for at least one meal daily. Also, there is no nutritional information listed on many restaurant, fast food or take-out meals. To the extent that some restaurants provide nutritional information, e.g., on their websites, the presentation of such information is often complicated, and the information is often listed by single topping or ingredient or in serving sizes that do not correspond to typical meals consumed, and in any event is generic as to all consumers.

Fast food, although convenient, has a reputation of poor quality, and being high in sodium, fat, and carbohydrates, which is undesirable from a nutrition perspective (Wu & Sturm, 2013; Fryar, et al, 2018; Todd, 2017; Rahkovsky, et al, 2018). Poor choices from the menu at fast food or restaurant menus can contribute to major health conditions affecting a large percentage of Americans.

However, increasingly, fast food outlets and restaurants are offering relatively “healthy” choices and listing the calories and ingredients of their menu items. Diet and exercise can be used to manage health conditions such as cardiovascular disease, high blood pressure, diabetes, and fatty liver. There are sound scientific principles and guidelines used for nutrition-decision making, and there may be certain menu items that contain specific nutrients and consistent with limits or other values recommended by various nutritional guidelines, such as those of the American Dietetic Association, American Heart Association, U.S. Department of Agriculture, Dietary Guidelines for Americans and the American Diabetes Association.

What is needed is a system and method providing for user interface management that displays information and guidance that is relevant to a person's selection of food items that are healthier generally and/or in relation to each person's particular dietary needs and preferences.

### SUMMARY

The present invention provides a computerized system and method for user interface management that displays information and guidance that is relevant to a person's selection of food items that are healthier generally and/or in relation to each person's particular dietary needs and preferences. More particularly, the system gathers and tracks dietary needs and preferences on a per-user basis, references nutritional information for standardized restaurant menu items, and makes personalized menu item recommendations based on each user's dietary needs and preferences. Accordingly, the system may enable a person to make relatively healthy food choices even when ordering restaurants that have standardized restaurant menu items with standardized nutritional content information, even for so-called “fast food” restaurants.

Further, the system may track past consumption, e.g., on a daily basis, and associated nutritional information consider such past consumption in making personalized recommendations.

Further still, the system may have geolocation/location-aware functionality, and may identify nearby restaurants and associated restaurant menu items in support of making of suitable menu item recommendations according to each user's dietary needs and preferences. Accordingly, the user can provide via the system's user interface information that can be used to establish the user's dietary profile, and then the system identifies recommended menu items according to nutrients known to be associated the menu item, to provide the user with an easily-accessible, actionable plan for eating healthier food items consistent with the user's dietary needs and preferences.

### BRIEF DESCRIPTION OF THE FIGURES

For a better understanding of the present invention, reference may be made to the accompanying drawings in which:

FIG. 1 is a system diagram showing an exemplary network computing environment in which the present invention may be employed;

FIG. 2 is a schematic diagram of an exemplary special-purpose Personalized Menu Item Recommendation System in accordance with an exemplary embodiment of the present invention;

FIG. 3 is a flow diagram illustrating an exemplary method for user interface management to provide a display if information and guidance relevant to a person's selection of food items according to each person's particular dietary needs and preferences, in accordance with an exemplary embodiment of the present invention; and

FIGS. 4-22 illustrate exemplary graphical user interface windows displayable by the exemplary special-purpose Location-Aware Menu Item Recommendation Devices and/or Personalized Menu Item Recommendation System in accordance with an exemplary embodiment of the present invention.

### DETAILED DESCRIPTION

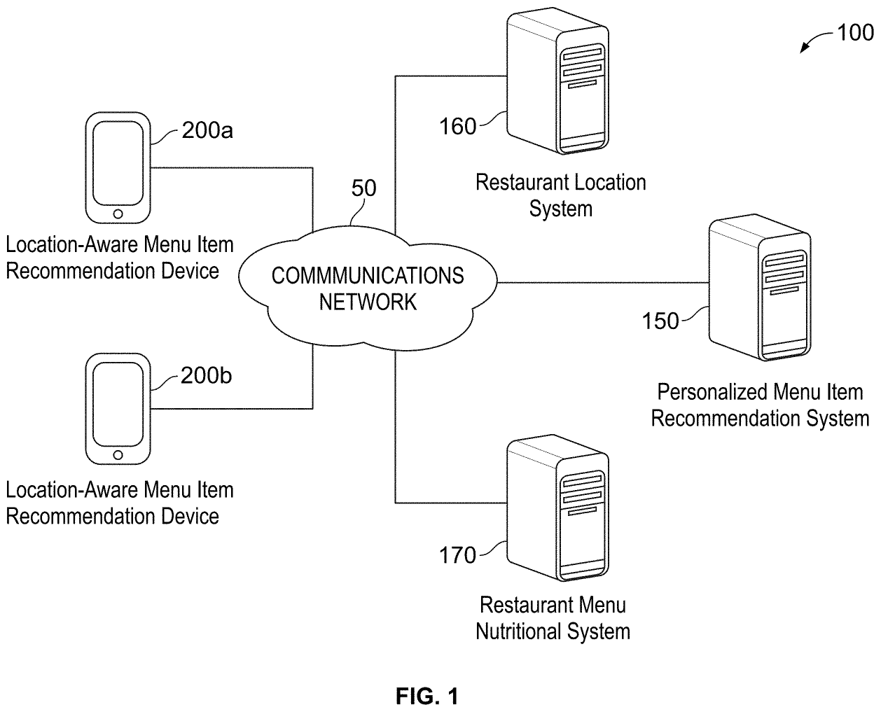

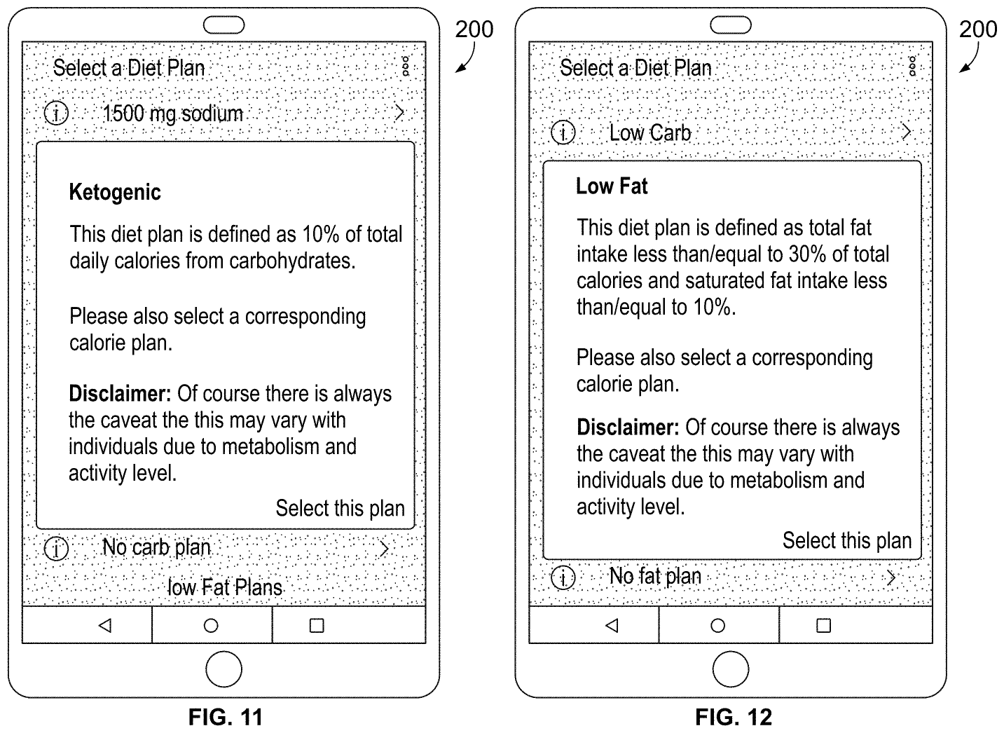

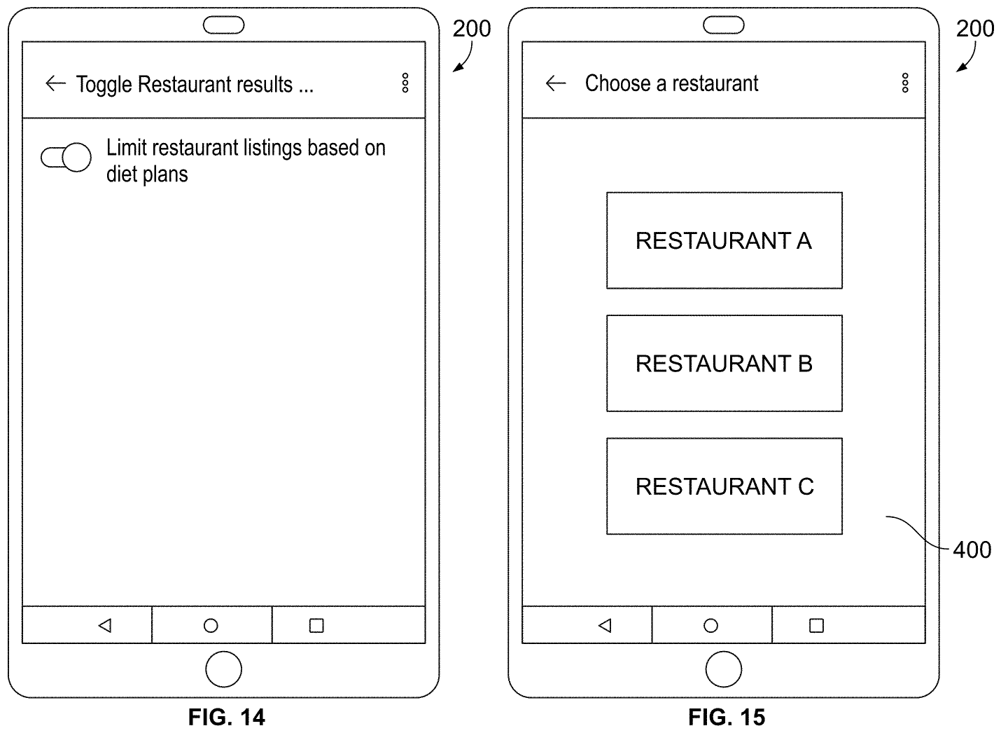

According to illustrative embodiment(s) of the present invention, various views are illustrated in FIGS. 1-22 and like reference numerals are used consistently throughout to refer to like and corresponding parts of the invention for all of the various views and figures of the drawings.

The following detailed description of the invention contains many specifics for the purpose of illustration. Any one of ordinary skill in the art will appreciate that many variations and alterations to the following details are within scope of the invention. Accordingly, the following implementations of the invention are set forth without any loss of generality to, and without imposing limitations upon, the claimed invention.

### System Environment

An exemplary embodiment of the present invention is discussed below for illustrative purposes. FIG. 1 is a system diagram showing an exemplary network computing environment 100 in which the present invention may be employed. As shown in FIG. 1, the exemplary network environment 100 includes conventional computing hardware and software for communicating via a communications network 50, such as the Internet, etc., using Location-Aware Menu Item Recommendation Devices (LAMIRDs) 200a, 200b, each of which may be, for example, one or more personal computers/PCs, laptop computers, tablet computers, smartphones, or other computing device hardware.

In accordance with a certain aspect of the present invention, one or more of the Location-Aware Menu Item Recommendation Devices 200a, 200b may store and execute an “app” or other purpose-specific application software in accordance with the present invention, although this is not required in all embodiments.

In accordance with the present invention, the network computing environment 100 may further include a Personalized Menu Item Recommendation System (PMIRS) 150, which may include hardware and/or software similar to that of the LAMIRD 200a, 200b. In this exemplary embodiment, the PMIRS 150 is operatively connected to the Location-Aware Menu Item Recommendation Devices 200a, 200b for data communication via the communications network 50. In this embodiment, though optional, the PMIRS 150 is operable to store user account information, user selections of diet plan profiles, foot consumption data, and other data associated with user accounts. This allows, for example, a user to switch smartphones/devices while maintaining continuity in use of the system, history, etc. but storing in the cloud/at the PMIRS 150 user-specific data that could also or alternatively be stored at the LAMIRD 200a, 200b. For example, the PMIRS 150 may receive data or user inputs from each Location-Aware Menu Item Recommendation Device 200a, 200b by data communication via the communications network 50. Hardware and software for enabling communication of data by such devices via such communications networks are well known in the art and beyond the scope of the present invention, and thus are not discussed in detail herein.

In certain embodiments, the PMIRS 150 may be implemented in whole or in part using a data storage cloud-based service, such as a the commercially-available Google Firebase cloud-based service, which may be configured to receive data via an application program interface (API) or otherwise, and to return results in the form of data to the Location-Aware Menu Item Recommendation Devices 200a, 200b.

### Location-Aware Menu Item Recommendation Device

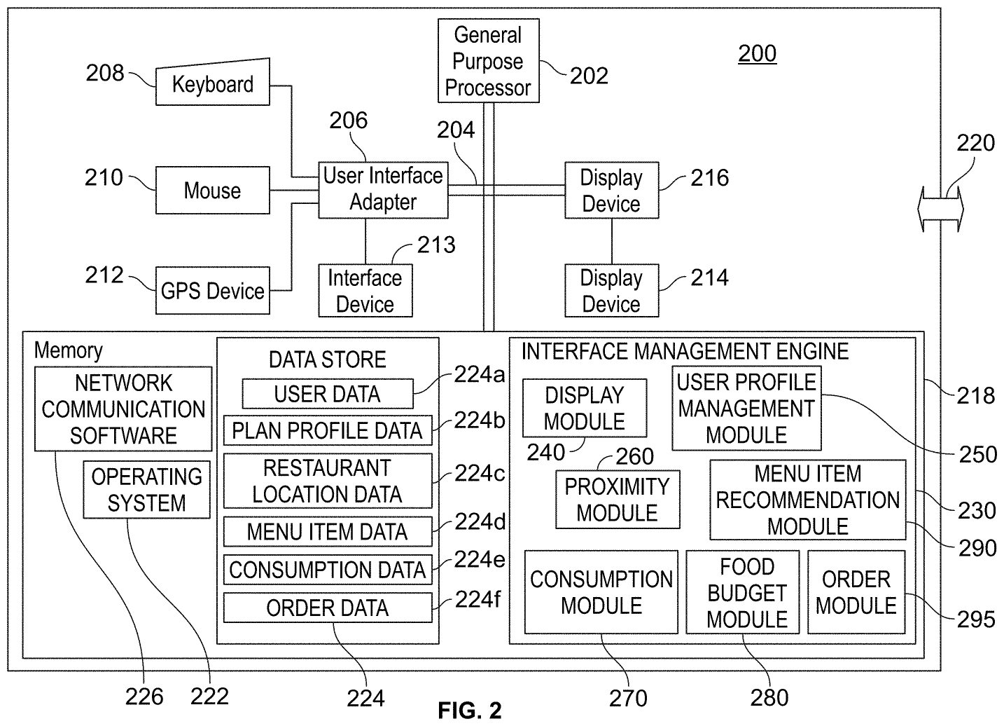

FIG. 2 is a block diagram showing an exemplary Location-Aware Menu Item Recommendation Device (LAMIRD) 200 in accordance with an exemplary embodiment of the present invention. The LAMIRD 200 is a special-purpose computer system that includes conventional computing hardware storing and executing both conventional software enabling operation of a general-purpose computing system, such as operating system software 222, network communications software 226, and specially-configured computer software for configuring the general-purpose hardware as a special-purpose computer system for carrying out at least one method in accordance with the present invention. By way of example, the communications software 226 may include conventional web server software, and the operating system software 222 may include iOS, Android, Windows, Linux software.

Accordingly, the exemplary LAM IRD 200 of FIG. 2 includes a general-purpose processor, such as a microprocessor (CPU), 102 and a bus 204 employed to connect and enable communication between the processor 202 and the components of the presentation system in accordance with known techniques. The exemplary presentation system 200 includes a user interface adapter 206, which connects the processor 202 via the bus 204 to one or more interface devices, such as a keyboard 208, mouse 210, global position system (GPS) device 212, and/or other interface devices 213, which can be any user interface device, such as a camera/imaging device, microphone, touch sensitive screen, digitized entry pad, etc. The bus 204 also connects a display device 214, such as an LCD screen or monitor, to the processor 202 via a display adapter 216. The bus 204 also connects the processor 202 to memory 218, which can include a hard drive, diskette drive, tape drive, etc.

The LAMIRD 200 may communicate with other computers or networks of computers, for example via a communications channel, network card or modem 220. The LAMIRD 200 may be associated with such other computers in a local area network (LAN) or a wide area network (WAN). Such configurations, as well as the appropriate communications hardware and software, are known in the art.

The LAMIRD 200 is specially-configured in accordance with the present invention. Accordingly, as shown in FIG. 2, the LAMIRD 200 includes computer-readable, processor-executable instructions stored in the memory 218 for carrying out the methods described herein. Further, the memory 218 stores certain data, e.g., in one or more databases or other data stores 224 shown logically in FIG. 2 for illustrative purposes, without regard to any particular embodiment in one or more hardware or software components.

Further, as will be noted from FIG. 2, the LAMIRD 200 includes, in accordance with the present invention, a User Interface Management Engine (UIME) 230, shown schematically as stored in the memory 218, which includes a number of additional modules providing functionality in accordance with the present invention, as discussed in greater detail below. These modules may be implemented primarily by specially-configured software including microprocessor-executable instructions stored in the memory 218 of the LAMIRD 200. Optionally, other software may be stored in the memory 218 and and/or other data may be stored in the data store 224 or memory 218.

As shown in FIG. 2, the exemplary embodiment of the LAMIRD 200 also includes a Display Module (DM) 240. The DM 240 is responsible for causing display of graphical user interface windows at the LAMIRD 200 and for receiving user inputs via the LAMIRD 200.

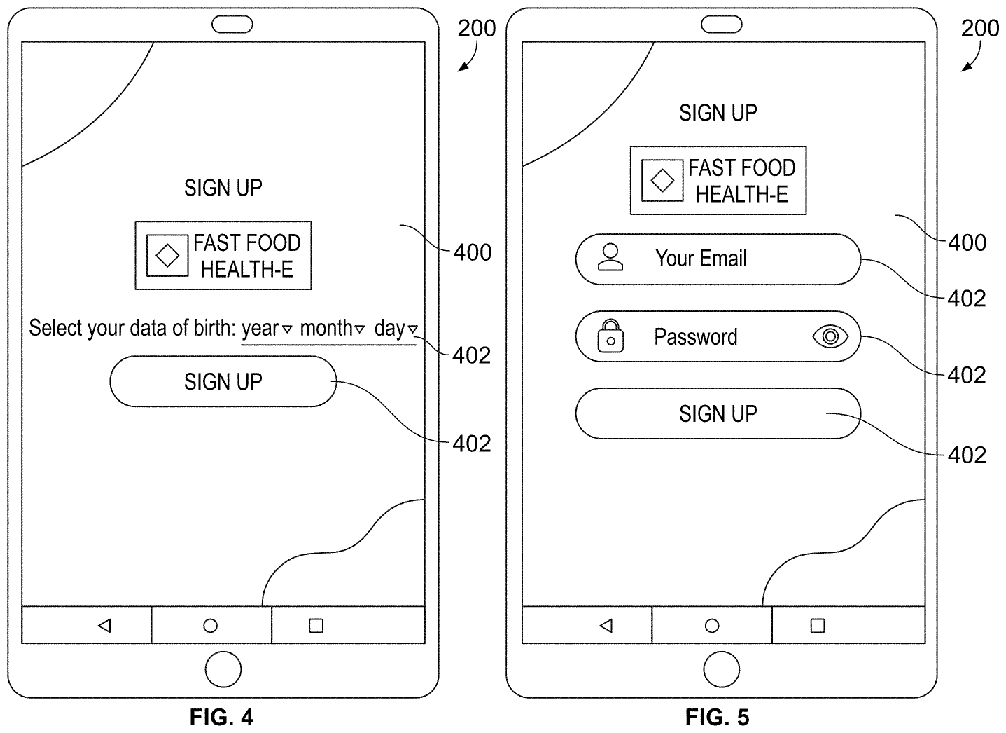

For example, the DM 240 may cause display of graphical user interface windows displaying user-selectable options for navigating a user interface and provide data/user inputs in accordance with the present invention, as will be appreciated from FIGS. 4-25. Accordingly, users can interact with the LAMIRD 200 and its user interface in accordance with the present invention, e.g., to select user-selectable options, e.g., to perform view personalized menu item recommendations, etc., as discussed in greater detail below.

In accordance with the present invention, the exemplary embodiment of the LAMIRD 200 shown in FIG. 2 also includes a User Profile Management Module (UPMM) 250. The UPMM 250 is responsible for, in concert with the Display Module 240, causing display of graphical user interface windows for gathering user data to be used for the purpose of the present invention. Such data may include typical user account data, such as name, email address, login username, password, birthdate, etc. Notably, such information includes a user's selection of a diet plan profile to be used to make menu item recommendations in accordance with the present invention. Diet plan profiles are standardized diet plan profiles stored in the Device 200 and available for use by one or more users. By way of example, the dietary plan profiles may be designed to confirm to common nutritional guidelines as may be defined by the American Heart Association, American Diabetes Association, American Liver Foundation, Dietary Guidelines for Americans, Academy of Nutrition and Dietetics or otherwise as being appropriate to people having various different dietary needs, such as those that as may be associated with a physical condition (such as heart disease, diabetes, etc.) or other preferences, such as kosher, low fat, low sodium, vegan, gluten free, etc. For example, each diet plan profile may define a suitable dietary “budget” of daily (or other periodic) nutritional targets or limits, which may be expressed, for example, in terms of macronutrients or micronutrients, such as gms carbohydrates, gms fats, and mg sodium, gms protein, gms, sugar, non-dairy, gluten-free, 1200 daily calorie limit, 1500 daily calorie limit, 2000 daily calorie limit, etc. For example, an exemplary diet plan profile might be defined to place daily (or other periodic) targets/limits of calories per day (e.g., 2000 calories/day, 1500 calories/day, or 1200 calories/day), number of meals per day (e.g., 2 or 3), preferences such as a low-sodium=content preference (e.g., limiting sodium to 2000 mg/day), or a low-carbohydrate-content preference (e.g., limiting carbohydrates to less than 40% of calories per day). By way of example, the budget of 2000 mg/day may be allocated equally to all meals (e.g., 2000/mg per day/2 meals/day=1000 mg/meal), or unequally according to any desired allocation. The UPMM 250 may retrieve plan profile data from the Plan Profile Data 224b in the Data Store 224, and may store data identifying a user and the user's diet plan profile selection in the data store 224 as User Data 224a.

In accordance with the present invention, the exemplary embodiment of the LAMIRD 200 shown in FIG. 2 also includes a Proximity Module (PM) 260. The PM 260 is responsible for obtaining and/or receiving geolocation data from the GPS Device 212 of the LAMIRD 200. As known in the art and as used in many smartphone or similar applications, the geolocation data may be tracked and/or made available for use by the operating system of the LAM IRD 200 to indicate a current geographical location of the LAMIRD 200. The PM 260 is further responsible for obtaining Restaurant Location Data, and in a preferred embodiment, filtering the Restaurant Location Data to identify specific restaurants that are close the present location of the LAM IRD, based on the Restaurant Location Data and the current geographical location of the LAMIRD 200, and then displaying information identifying only the close restaurants. The definition of “close” may vary in any suitable manner, but in one embodiment, a restaurant location may be defined as close if it is determined to be within a particular distance radius from the current location, such as within 10 miles or 20 miles, etc., or within a particular driving time, as may be estimated using functionality similar to that of vehicle navigation system, e.g., to determine that the restaurant is within 20 minutes or 30 minutes, etc. of driving time. Use of a definition of “close” matching that of a delivery area of a food delivery service, such as Uber Eats, DoorDash or GrubHub may be advantageous for reasons discussed in further detail below. It may be preferable to identify only restaurants, such as fast food, or chain”/franchise-type restaurants, that have standardized menus, and consistent menu item offerings having consistent nutritional information, for reasons discussed below. By way of example, the Proximity Module might be used to determine that certain McDonalds, Burger King, Wendy's, and Appleby's restaurants are “close” to the current geographical location of the LAMIRD 200. The PM 250 may retrieve restaurant location data from the Restaurant Location Data 224c in the Data Store 224 and/or from the Restaurant Location System 160 (such as may be available via the Google Maps API, Apple Maps API, etc.).

Further, in accordance with the present invention, the exemplary embodiment of the LAMIRD 200 shown in FIG. 2 also includes a Consumption Module (CM) 270. The CM 270 is responsible for, in concert with the DM 240, displaying graphical user interface windows for gathering information relating to a user's food consumption in terms of food items and/or nutrients, for food budget tracking purposes. For example, a user may enter into LAM IRD 200 a record of items consumed in a relevant, e.g., daily, period, e.g., by meal, by day, etc., including those that are not restaurant menu food items and/or those that are not ordered via the LAM IRD 200. Additionally, the CM 270 may record items that are browsed and/or ordered via the LAM IRD 200, and store associated data as Consumption Data 224e for the user in the Data Store 224. Further, the CM 270 may a record of food consumption for a relevant period, such as a daily period. The CM 270 may store data providing a record of food consumption in the data store 224 as Consumption Data 224e.

Further still, in accordance with the present invention, the exemplary embodiment of the LAMIRD 200 shown in FIG. 2 also includes a Food Budget Module (FBM) 280. The FBM 280 is responsible for determining an appropriate periodic (e.g., daily) food budget in terms of nutritional information, etc., and determining a remaining available food budget for the period, and for accounting for expected remaining meals and or past periodic (e.g., daily) food consumption to define nutritional guidelines for selecting a restaurant menu food that is consistent with the then-available food budget. For example, the FMB 280 may identify that the user is adhering to a food profile providing a daily food budget of 40 gms of carbohydrates (e.g., by reading selected plan profile data from the User Data 224a stored in the Data Store 224), may determine that the user has already consumed 20 gms of carbohydrates in the same period (e.g., by reading consumption data 224e from the Consumption Data 224e in the Data Store 224), may determine that 2 meals likely remain for the day, and may determine a recommended food budget for the next meal of 10 gms of carbohydrates (leaving 10 gms for the final meal of the same period).

Still further, in accordance with the present invention, the exemplary embodiment of the LAMIRD 200 shown in FIG. 2 also includes a Menu Item Recommendation Module (MIRM) 290. The MIRM 290 is responsible for retrieving menu item data, e.g., from Menu Item Data 224d stored in the Data Store 224 of the LAMIRD, or from an internet-accessible resource providing such information, such as the Restaurant Menu Nutritional System (RMNS) 170. By way of example, the RMNS 170 may provide menu item and related nutritional information data for a variety of fast food and/or other restaurants having standardized menu items, such as data that is available from the commercially-available Nutritionix database provided by Syndigo LLC of Chicago, Ill. In certain embodiments, the MIRM 290 is configured to compare the menu item nutritional data (for the relevant restaurant) to the available food budget data determined by the FBM to identify one or more menu item selections to be deemed as “recommended” because they match or best match the available food budget data. Further, the MIRM 290 is responsible for, acting in concert with the DM 260, displaying recommended menu items, and preferably only the recommended menu items, to the user via the display device 214 of the LAM IRD 200, so that the user and view and consider the recommended selections, and have the opportunity to make a relatively healthier choice to consume a food item that better matches the user's specific dietary needs and preferences.

Still further, in accordance with this exemplary embodiment of the present invention, the LAM IRD 200 shown in FIG. 2 also includes an Order Module (OM) 295. The OM 295 is responsible for retrieving placing an order to purchase and/or to have delivered to the user, a selected menu item, which may be chosen from among the recommended menu items identified by the MIRM 290. By way of example, this may be performed by electronic exchange of data (via the communications network 50) to a Restaurant Ordering System and/or a Food Delivery Service's computerized system, as is generally known in the art in relation to UberEats, DoorDash, etc. In this manner, and particularly when the definition of “close” is used to match a delivery area of such food delivery services, the user may have a seamless restaurant menu item ordering/delivery experience. Additionally, the OM 295 may be responsible for adding the ordered menu item to the Consumption Data, e.g., by acting in concert with the Consumption Module 270, so that the nutritional data associated with the ordered meal may be considered in determining a remaining food budget for a future menu item selection. Order data reflecting past orders may also be stored as Order Data 224f in the Data Store 224.

It should be appreciated that in the embodiment described above, data is stored and retrieved locally on the LAM IRD, but that in other embodiments, some or all of the data may be stored and retrieved, and/or some of the functions described herein, may be performed outside of the LAM IRD 200, e.g., by a cloud-based service and associated hardware, such as at PMIRS 150.

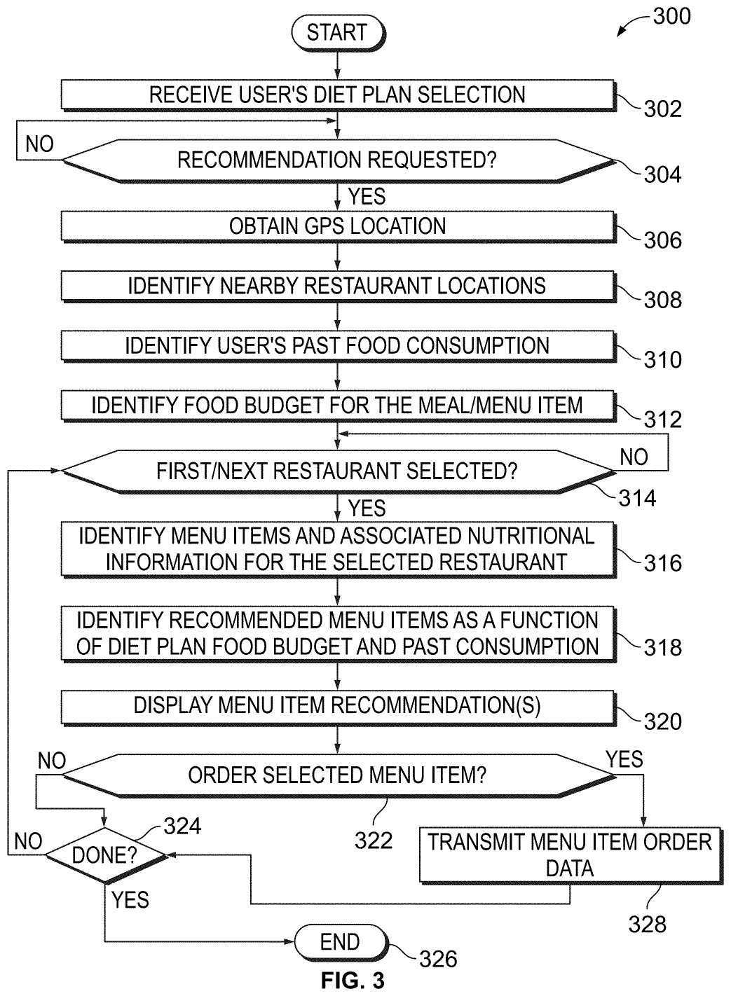

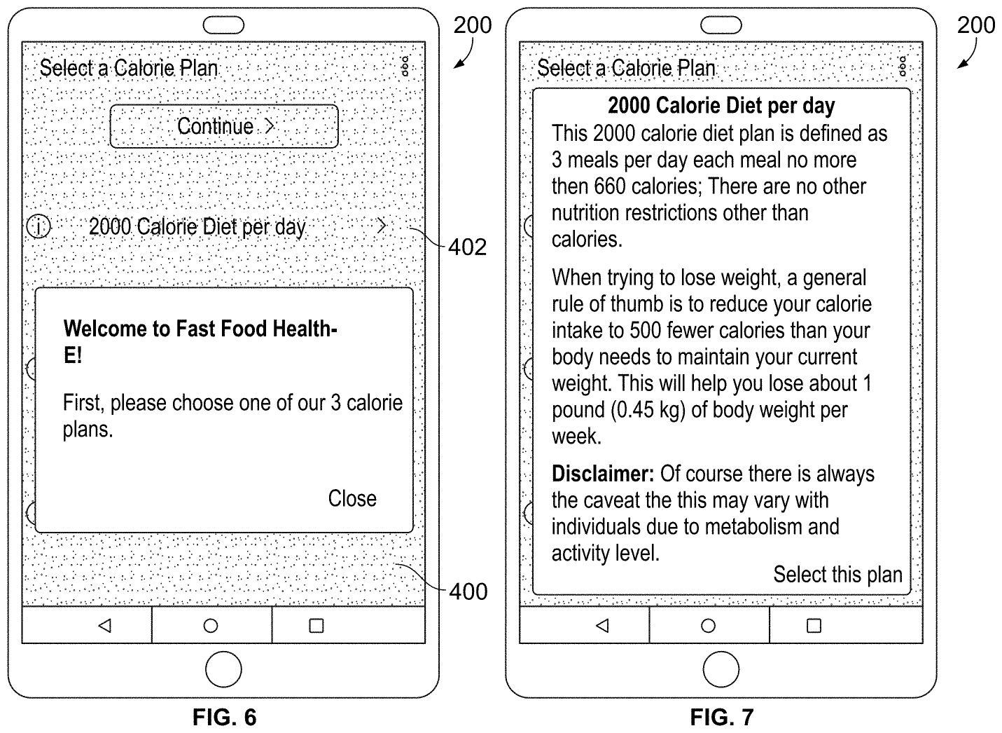

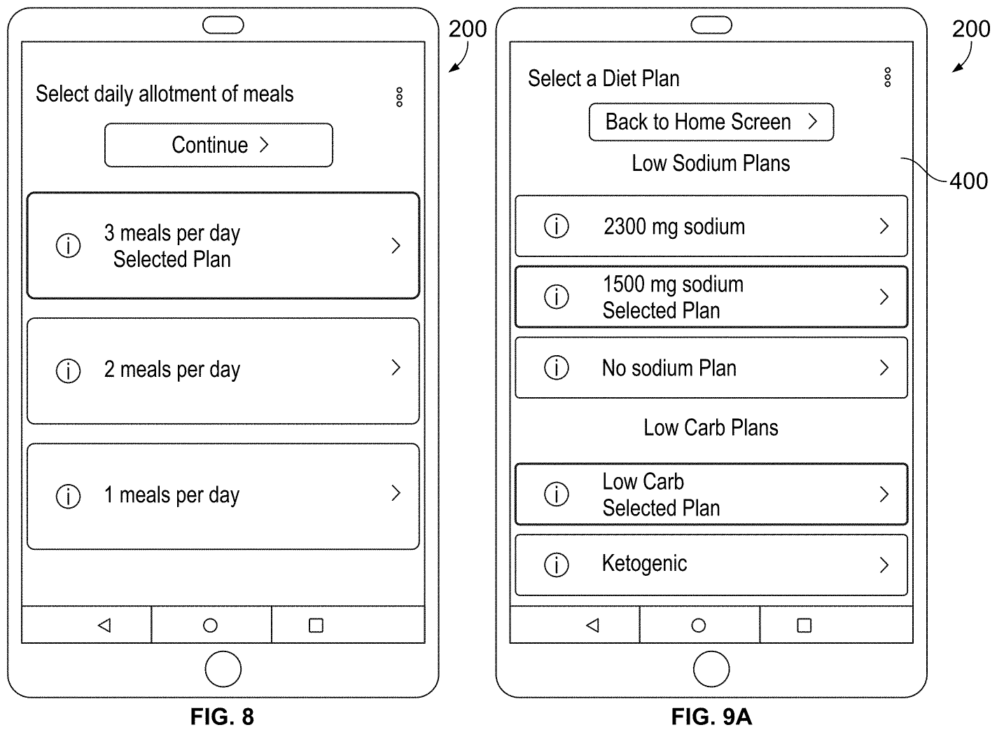

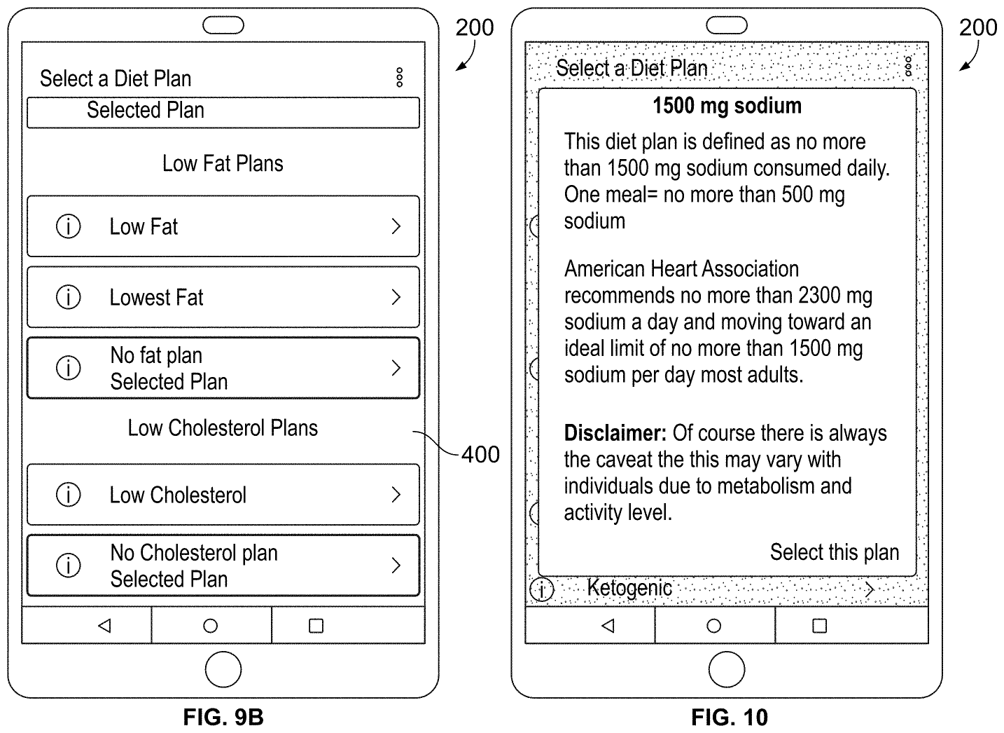

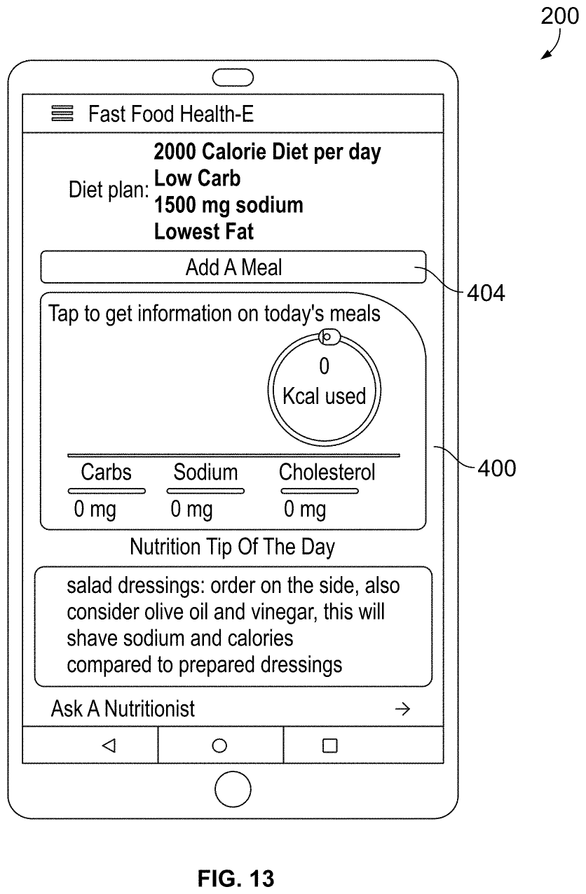

FIG. 3 shows a flow diagram 300 illustrating an exemplary method for user interface management, carried out by the LAMIRD 200, to provide personalized dietary recommendations and tracking in accordance with an exemplary embodiment of the present invention. Referring now to FIG. 3, the exemplary method begins with receipt of a user's diet plan profile selection(s) as shown at 302. This may be determined by the user's selection of various user-selectable buttons and/or other user-manipulable elements 402 displayed as part of a graphical user interface window 400 caused to displayed on the display device 214 of an LAMIRD 200a, 200b by the Display Module 240 as part of creation of a new user account, as managed by the User Profile Management Module 250 acting in concert with the Display Module 240. See FIGS. 4-12. The UPMM 250 may retrieve plan profile data from the Plan Profile Data 224b stored in the Data Store 224, and may store user data as User Data 224a in the Data Store 224, to record selections and/or other information relevant to each particular user, as will be appreciated from FIG. 2. In this exemplary embodiment, the UPMM 250 and Display Module 240 act in concert to display graphical user interface windows, and receive user input, in relation to the user's date of birth (FIG. 4), email address and password for account creation purposes (FIG. 5), calorie plan selection (FIG. 6), meal frequency selection (FIG. 8), Low Sodium Plan, Low Carbohydrate, Low Cholesterol and Low Fat plan options, etc. (FIGS. 9A and 9B). Additionally, the UPMM 250 and Display Module 240 act in concert to display graphical user interface windows providing information, such as informative text, relating to the various options, as will be appreciated from FIGS. 7 and 10-12. The result of this process is selection/definition of a particular diet plan profile for a particular user, and associated information is stored in association with the user in the User Data 224a. For example, FIG. 13 shows a graphical user interface window 400 indicating that the user has selection a Diet Plan Profile involving a 2000 calories per day limit/target, a low carb preference, a 1500 mg sodium limit/target, and a lowest fat preference. Further, these plan profiles are defined, in the stored Plan Profile Data 224b, to be associated with other limits/targets, such as targets/limits for gms of carbohydrates, sodium and cholesterol, for example. These diet plan parameters will be used by the system for making restaurant food menu item recommendations that are personalized to the particular dietary needs and preferences of this particular user when requested by the user.

Accordingly, as will be appreciated from FIG. 3, the exemplary method effectively waits until a menu item recommendation is requested by a user, as shown at 304. In this exemplary embodiment, a menu item recommendation can be selected from the user interface window of FIG. 13 by selecting the user-selectable Add A Meal button 404.

When the Add A Meal button 404 displayed in FIG. 13 is selected, the user has requested a menu item recommendation, as shown at 304 in FIG. 3, and the method proceeds to obtain a GPS location, namely, geolocation data obtained from GPS Device 212 hardware of a type common to or similar to that in many conventional smartphones. As known in the art, the geolocation data produced by the GPS Device 212 identifies a current geographical location (e.g., in the form of latitudinal and longitudinal coordinates) of the LAMIRD 200a, 200b. This is performed under control of the Proximity Module 260, by interfacing with the GPS Device 212, either directly or via data made accessible via the Operating System 222.

The method then proceeds to identify nearby restaurant locations that are in close proximity to the current location identified, as shown at 308. This is performed under control of the Proximity Module 260. In this example, this is performed by referencing restaurant location data 224c stored in the Data Store 224 of the LAMIRD, and/or by, for example, sending a query via the communications network 50 to an external system, such as the Restaurant Location System 160, which may be, or may be implemented in part, by sending a query via a Google Maps API to identify nearby restaurant locations, as known in the art. Any suitable parameter may be used to determine whether a restaurant is nearby, such as a difference between coordinates, a corresponding calculated linear distance, a driving distance, a time for driving the distance, etc., e.g., according to system parameters, user selection, or user preference. The Restaurant Location Data 224c and/or the Restaurant Location System may identify only those restaurants that have standardized menus and menu item nutritional content, by design. The Google Maps API or a similar implementation may return all restaurants, and the Proximity Module may filter the results to identify only nearby restaurants that have standardized menus and menu item nutritional content, e.g., using data stored in the Restaurant Location Data 224c. The Proximity Module 260, acting in concert with the Display Module 240, then causes display of a suitable list of restaurants in a graphical user interface window 400, as shown in FIG. 15.

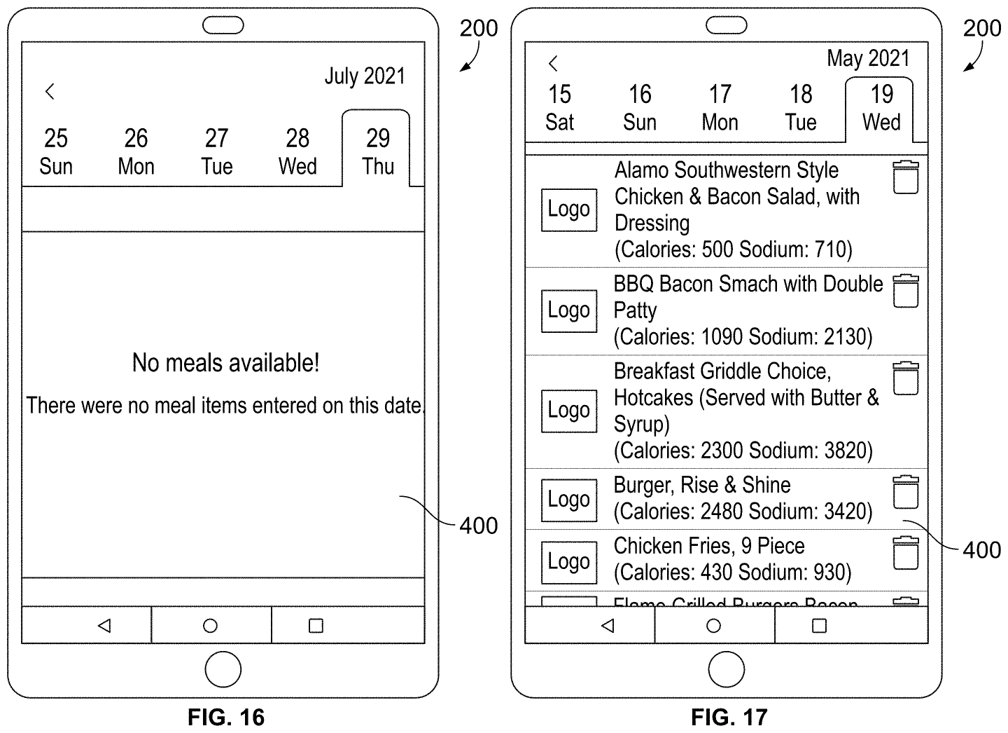

In this exemplary embodiment, the method then identifies the users past food consumption for the relevant period (daily in this example), as shown at 310. This is performed by the Consumption Module 270, and may involve retrieval of data from the Consumption Data 224e, e.g. to identify already-consumed calories, carbohydrates, sodium, cholesterol, etc. associated with prior meals recorded as a result of purchase via the LAMIRD 200a, 200b (and storage in Consumption Data 224e), and/or recorded as a result of user input to the LAM IRD 200a, 200b (and storage in Consumption Data 224e). For example, FIGS. 16 and 17 show exemplary graphical user interface windows 400 displaying past consumption data for various dates, by way of example.

In this exemplary embodiment, the method then identifies the food budget for the users meal, as shown at 312. This is performed by the Food Budget Module 280, and may involve retrieval of data from the User Data 224a (to show the users selection of a diet plan profile allowing for 2000 calories/day, 1500 mg sodium/day, with low carb and lowest fat preferences), and/or may involve retrieval of data from the Plan Profile Data 224b, e.g. to identify carbohydrate, sodium, cholesterol and/or other limits, preferences etc. as defined in the Plan Profile Data 224b. Further, this involves determining an available portion of the periodic (daily) food budget that is available for the next meal. This may involve consideration of the total periodic full budget and associated nutritional parameters, the past consumption for the period and associated nutritional parameters, and an allocation of a remainder of the food budget to the next meal, which may involve reserving a portion of the food budget for a future meal, based on past number of meals, meal frequency, etc.

If it is determined at 314 that a first/next restaurant is selected, e.g., from the list of nearby restaurants displayed via the LAMIRD 200a, 200b as shown in FIG. 15, at 314, then menu items of the nearby restaurant, and menu item nutritional information or those menu items are identified for the nearby/selected restaurant; as shown at 316. This is performed by the Menu Item Recommendation Module 290, and may involve retrieval of a list or menu items and associated menu item data; e.g., from Menu Item Data 224d stored in the Data Store 224 of the LAMIRD 200 as shown in the exemplary embodiment of FIG. 2 and/or by transmitting data via the communications network 50 to an external system, such as Restaurant Menu Nutritional System 170 shown in FIG. 1. This may involve, for example, a query to a database of such information, such as a query of the commercially-available Nutritionix database.

The LAMIRD next identifies as recommended specific menu items at he selected restaurant as a function of the selected diet plan profile, the associated food budget and nutritional parameters, as shown at 318. This involves an analysis by the Menu Item Recommendation Module 290, and may involve comparison of the remaining/allocated portion of the food budget and associated nutritional parameters to the nutritional information of the available restaurant menu items, to determine items that are a best fit and/or are generally consistent, or relatively more consistent, with the particular user's dietary needs and preferences, based on past consumption.

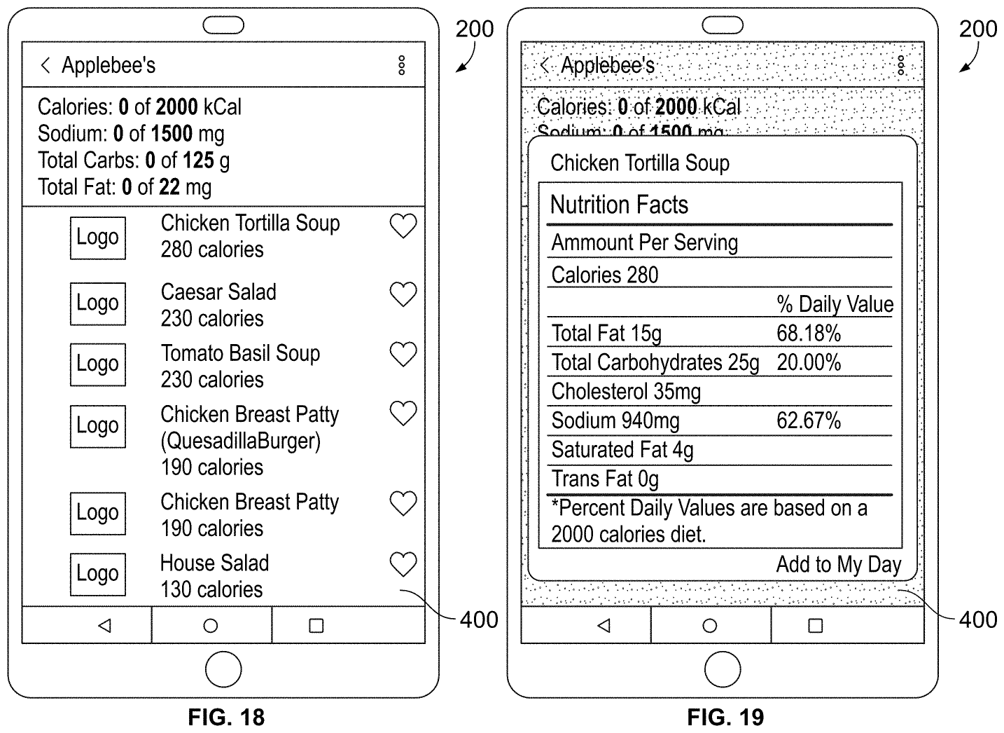

The Menu Item Recommendation Module 290, acting in concert with the Display Module 240, then displays, via the Display Device 214 of the LAMIRD 200, the recommended menu items at the selected restaurant selected by the user from the list of displayed nearby restaurants having suitable standardized menu items with consistent nutritional information, and the user's past consumption and associated nutritional parameters, as shown at 320. FIG. 18 shows an exemplary graphical user interface window 44 displaying a list of recommended menu items, at the selected Appleby's restaurant; that are recommended as consistent with the user's dietary needs/preferences in view of the selected diet plan profile and past consumption. The user may browse this list to select a relatively healthier menu item, without being “tempted” by relatively less healthy menu options, which are not displayed as user-selectable options, but rather are excluded from the list of available menu items. The user may select a particular option to browse additional information, which will be displayed by the Menu Item Recommendation Module, acting in concert with the Display Module 240, as shown in FIG. 19.

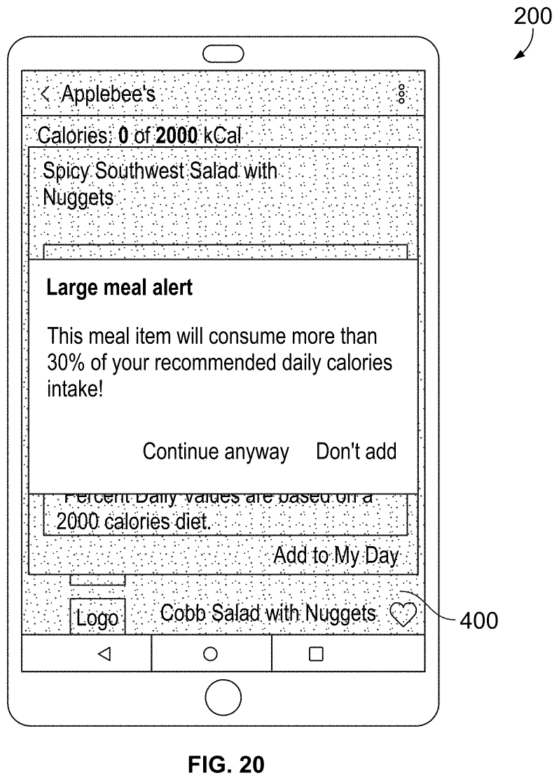

In certain embodiments, all menu items may be displayable and displayed, including menu items that are not recommended, and the Menu Item Recommendation Module 290 may be operable to display a warning message if, for example, a selected menu item may have a disproportionate or otherwise impact on the remaining food budget—e.g., to require a large proportion of the budget, as shown in FIG. 20. For example, if the user chooses a menu item that is NOT within their designated diet plan framework (e.g., accounting for calorie, sodium, carbohydrate, fat, number of meals and/or other limits), the computer application will display the warning message. For example, a user may choose a 2000 calorie plan that limits sodium content to a low sodium value as recommended by the American Heart Association. This would limit the sodium to 2000 mg per day. The user would provide the number of meals they eat per day. If the user reports 2 meals per day, then the computer application would limit each meal to 1000 mg of sodium per meal. In certain embodiments, only menu items containing 1000 mg of sodium or less would be displayed for the user to choose from. In other embodiments, in which menu items are displayed that are not recommended, if the user chooses a menu item containing 1700 mg of sodium, the computer will display a message that this menu item is NOT within their designated meal plan.

If a particular displayed recommended menu item is desired by the user, then, in certain embodiments with optional ordering functionality, the user may select a button displayed in the graphical user interface to order the desired menu item, as shown at 322. This is performed by the Order Module 295 acting in concert with the Display Module 240.

If the user does not wish to order a selected menu item, then it is determined if the user is done the menu item browsing/ordering/recommendation process, as shown at 322 and 324. If the user is done, then the method ends, as shown at 324 and 326. If the user is not done, then method flow returns to 314 and another restaurant may be selected, and its menu items may be analyzed, recommended, ordered, etc. in a manner similar to that described above, as shown at 316-322.

If it is determined at 322 that the user wishes to order a particularly recommended menu item, then suitable data is transmitted to a suitable computer system of a restaurant, food delivery service, etc. for placing the order (typically via an API), as is generally known in the art, and as shown at 328. In instances in which the definition of “nearby” or “close” is matched to the delivery area of a food delivery service, this works particularly well.

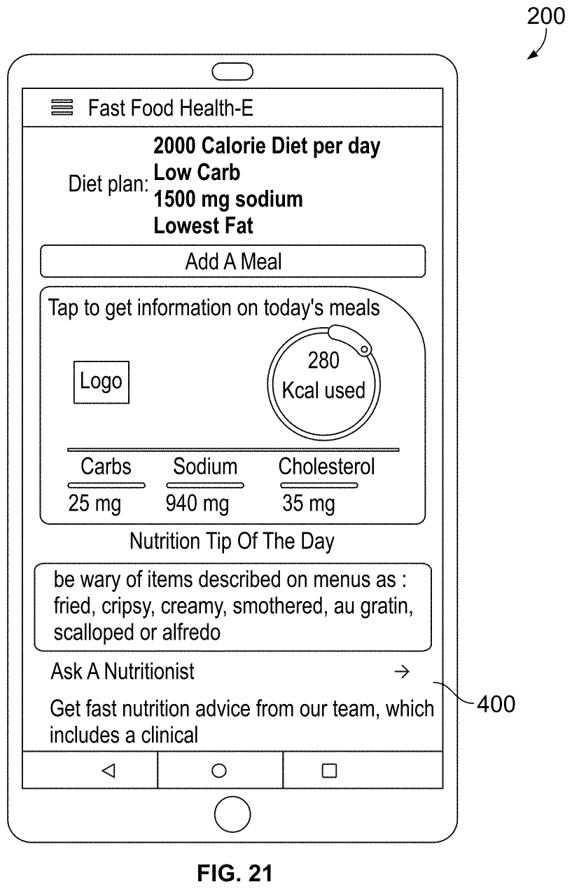

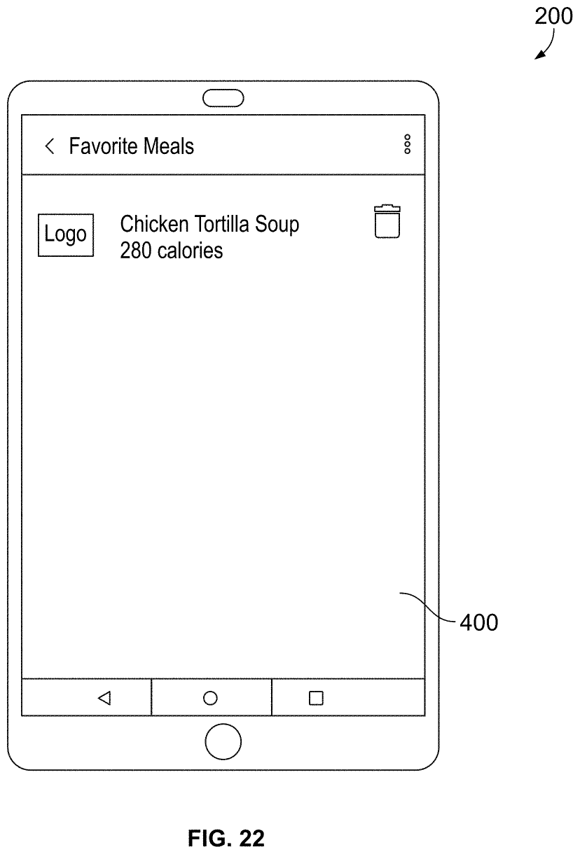

If an order is placed, then the ordered item may be deemed consumed, and the Consumption Module 270 may then record the “spending” of the relevant portion of the food budget, and update a display of calories, carbohydrates, sodium, cholesterol, etc. consumed to provide a visual representation of food consumption for a relevant period, as shown in the graphical user interface window 400 of FIG. 21. The Consumption Module records relevant data reflecting such consumption as Consumption Data 224e for further reference, and the Order Module may maintain a browsable log of ordered menu items as a list of Favorite Meals, and, acting in concert with the Display Module 240, display that list in a graphical user interface window 400, as shown in FIG. 22.

Then, the method proceeds to 324 and it is determined whether the user wishes to browse/order, etc. other food items, or to end the session, as described above.

Accordingly, it will be appreciated that the present invention provides a computerized system and method for user interface management that displays information and guidance that is relevant to a person's selection of food items that are healthier generally and/or in relation to each person's particular dietary needs and preferences. More particularly, the system gathers and tracks dietary needs and preferences on a per-user basis, references nutritional information for standardized restaurant menu items, and makes personalized menu item recommendations based on each user's dietary needs and preferences. Further, the system may track past consumption, e.g., on a daily basis, and associated nutritional information consider such past consumption in making personalized recommendations. Further still, the system may have geolocation/location-aware functionality, and may identify nearby restaurants and associated restaurant menu items in support of making of suitable menu item recommendations according to each user's dietary needs and preferences.

The various implementations and examples shown above illustrate a method and system for user interface management that provides an augmented reality-based experience that delivers real-time visual cues to a cognitively impaired person. using an electronic device. However, the device could be used in contexts other than for cognitively impaired persons, e.g., where recognition and/or situational awareness is needed such as learning names for objects and what they mean to a user, learning in another language, or learning a new skill, as an instructional aid. As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an exemplary embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a smart phone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system and client computers include a processor (e.g., a central processing unit (CPU), a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system and client computing devices also include an alphanumeric input device (e.g., a keyboard or touchscreen), a cursor control device (e.g., a mouse or gestures on a touchscreen), a drive unit, a signal generation device (e.g., a speaker and microphone) and a network interface device.

The system may include a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

The present invention may be operational with numerous other general-purpose or special-purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, cellular telephones, network PCs, minicomputers, mainframe computers, distributed computing environments that include any of the above-mentioned systems or devices, and the like.

The present invention has been described in the general context of computer-executable instructions, such as program modules or engines, being executed by a computer. Generally, program modules/engines include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules/engines may be located in local and/or remote computer-storage media including, by way of example only, memory storage devices.

The exemplary computing system may include general-purpose computing hardware in the form of a server. Components of the server may include, without limitation, a processing unit, internal system memory, and a suitable system bus for coupling various system components, including a database cluster, with the server. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The server typically includes therein, or has access to, a variety of computer-readable media, for instance, via a database cluster. Computer-readable media can be any available media that may be accessed by the server, and includes volatile and nonvolatile media, as well as removable and non-removable media. By way of example, and not limitation, computer-readable media may include computer-storage media and communication media. Computer-storage media may include, without limitation, volatile and nonvolatile media, as well as removable and non-removable media implemented in any method or technology for storage of information, such as computer readable instructions, data structures, program modules, or other data. In this regard, computer-storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information, and which may be accessed by the server. Communication media typically embodies computer readable instructions, data structures, program modules, or other data in a modulated data signal, such as a carrier wave or other transport mechanism, and may include any information delivery media. The term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The server may operate in a computer network using logical connections to one or more remote computers. Remote computers may be located at a variety of locations or over the Internet. The remote computers may be personal computers, servers, routers, network PCs, peer devices, other common network nodes, or the like, and may include some or all of the elements described above in relation to the server. The computing devices can be personal digital assistants or other like devices.

Exemplary computer networks may include, without limitation, local area networks (LANs) and/or wide area networks (WANs). Such networking environments are commonplace in offices, enterprise-wide computer networks, intranets, and the Internet. When utilized in a WAN networking environment, the server may include a modem/network card or other means for establishing communications over the WAN, such as the Internet. In a networked environment, program modules or portions thereof may be stored in the server, in the database cluster, or on any of the remote computers. For example, and not by way of limitation, various application programs may reside on the memory associated with any one or more of the remote computers. It will be appreciated by those of ordinary skill in the art that the network connections shown are exemplary and other means of establishing a communications link between the computers (e.g., the server and remote computers) may be utilized.

In operation, a user may enter commands and information into the server or convey the commands and information to the server via one or more of the remote computers through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote device to the server. In addition to a monitor, the server and/or remote computers may include other peripheral output devices, such as speakers and a printer.

Many other internal components of the server and the remote computers/computing devices are not shown because such components and their interconnection are well known. Accordingly, additional details concerning the internal construction of the server and the remote computers/computing devices are not further disclosed herein.

Although methods and systems of embodiments of the present invention may be implemented in a WINDOWS or LINUX operating system, operating in conjunction with an Internet-based delivery system, one of ordinary skill in the art will recognize that the described methods and systems can be implemented in any system supporting the functionality described herein. As contemplated by the language above, the methods and systems of embodiments of the present invention may also be implemented on a stand-alone desktop, personal computer, cellular phone, smart phone, tablet, PDA, or any other computing device used in various locations.

Additionally, computer readable media storing computer readable code for carrying out the method steps identified above is provided. The computer readable media stores code for carrying out subprocesses for carrying out the methods described herein.

A computer program product recorded on a computer readable medium for carrying out the method steps identified herein is provided. The computer program product comprises computer readable means for carrying out the methods described above.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A menu item recommendation device comprising:
a display device;
a user input device;
a memory comprising a non-transitory data processor-readable medium;
a data processor operatively connected to said memory, said display device and said user input device;
user interface management instructions embodied in data processor-executable code stored in the memory, said user interface management instructions being executable by the data processor to provide a user interface management engine configured to:
identify a list of comprising restaurants having standardized menu items having standardized nutritional content;
identify a food plan profile for a user, said food plan profile being associated with nutritional information targets;
identify a meal food budget for at least one food item to be consumed in a next meal, the food budget representing an available portion of a periodic food budget associated with the user's food plan profile;
display, on the display device, the list of restaurants;
receive a user's selection of a restaurant;
identify menu items and associated nutritional content information for each of a plurality of menu item of the selected restaurant;
identify at least one recommended menu item as a function of at least one of the meal food budget and the food plan profile; and
display, on the display device, a list including said at least one recommended menu item.

2. The menu item recommendation device of claim 1, wherein said user interface management instructions are further configured to provide a user interface management engine configured to:
obtain geolocation data for the menu item recommendation device; and
identify a list of restaurants in close proximity to the menu item recommendation device.

3. The menu item recommendation device of claim 2, wherein said user interface management instructions are configured to identify a list of restaurants in close proximity to the menu item recommendation device by performing at least one of:
referencing restaurant location data stored in the memory; and
sending a query as an electronic communication via a communications network to an external computing system.

4. The menu item recommendation device of claim 2, wherein said user interface management instructions are configured to identify a list of restaurants in close proximity to the menu item recommendation device using at least one of a difference between coordinates of the display device and a restaurant, a corresponding calculated linear distance, a driving distance, and a time for driving the driving distance, etc.

5. The menu item recommendation device of claim 2, wherein said user interface management instructions are configured to identify a list of restaurants in close proximity to the menu item recommendation device by filtering a list of nearby restaurants to identify only nearby restaurants that have standardized menu items having standardized menu item nutritional content.

6. The menu item recommendation device of claim 2, wherein said user interface management instructions configured to identify the list of restaurants in close proximity to the menu item recommendation device are configured to identify only restaurants having standardized menu items having standardized nutritional content.

7. The menu item recommendation device of claim 1, wherein said user interface management instructions configured to identify a food plan profile for a user comprises instructions to display a list of alternative food plan profiles and to receive a user's selection of input corresponding to one of said alternative food plan profiles.

8. The menu item recommendation device of claim 1, wherein said user interface management instructions are further configured to provide the user interface management engine configured to:
identify a past food consumption for a user for a particular period of time; and wherein said user interface management instructions configured to provide the user interface management engine configured to identify at least one recommended menu item are configured to identify said at least one recommended menu item as a function of at least one of the meal food budget, the food plan profile, and the past food consumption.

9. The menu item recommendation device of claim 1, wherein said user interface management instructions configured to identify menu items and associated nutritional content information for each of a plurality of menu item of the selected restaurant are further configured to:
retrieve a list of menu items and associated menu item data by transmitting a data query as a data communication via the communications network to an external computing system storing a database of such information.

10. The menu item recommendation device of claim 1, wherein said user interface management instructions configured to provide a user interface management engine configured to display, on the display device, a list including said at least one recommended menu item are further configured to display only recommended menu items.

11. The menu item recommendation device of claim 10, wherein said user interface management instructions configured to provide a user interface management engine configured to display, on the display device, a list including said at least one recommended menu item are further configured to display only recommended menu items as user-selectable options.

12. The menu item recommendation device of claim 10, wherein said user interface management instructions configured to provide a user interface management engine configured to display, on the display device, a list including said at least one recommended menu item are further configured to display a warning message if a selected menu item would have one of a disproportionate impact on and an incompatibility with a remaining food budget.

13. The menu item recommendation device of claim 1, wherein said user interface management instructions are further configured to provide a user interface management engine configured to display, on the display device, a user-selectable element operable to place an order to purchase a selected menu item.

14. The menu item recommendation device of claim 13, wherein said user interface management instructions are further configured to provide a user interface management engine configured to display, on the display device, an updated display of at least one of calories, carbohydrates, sodium and cholesterol that is reduced by the amount contained in the purchased selected menu item in response to a user's selection of an element operable to place an order to purchase a selected menu item.

15. A computer-implemented method of controlling a display of a computerized device to provide personalized dietary recommendations, the computerized device comprising a memory operatively comprising a non-transitory data processor-readable medium, a data processor operative connected to the memory, the display and the user input component, and user interface management instructions embodied in data processor-executable code stored in the memory and executable by the data processor, the method comprising:
obtaining geolocation data for the menu item recommendation device;
identifying a list of restaurants in close proximity to the menu item recommendation device, the list comprising only restaurants having standardized menu items having standardized nutritional content;
identifying a food plan profile for a user, said food plan profile being associated with nutritional information targets;
identifying a past food consumption for a user for a particular period of time;
identifying a meal food budget for at least one food item to be consumed in a next meal, the food budget representing an available portion of a periodic food budget associated with the user's food plan profile;
displaying, on the display device, the list of restaurants;
receiving a user's selection of a restaurant;
identifying menu items and associated nutritional content information for each of a plurality of menu item of the selected restaurant;
identifying at least one recommended menu item as a function of at least one of the meal food budget, the food plan profile, and the past food consumption; and
displaying, on the display device, a list including said at least one recommended menu item.

16. The method of claim 15, wherein said identifying a list of restaurants in close proximity to the menu item recommendation device comprises:
referencing restaurant location data stored in the memory; and
sending a query as an electronic communication via a communications network to an external computing system.

17. The method of claim 15, wherein said identifying the list of restaurants in close proximity to the menu item recommendation device comprises identifying only restaurants having standardized menu items having standardized nutritional content.

18. The method of claim 15, wherein said identifying a food plan profile for a user comprises displaying a list of alternative food plan profiles and receiving a user's selection of input corresponding to one of said alternative food plan profiles.

19. The method of claim 16, wherein said displaying, on the display device, the list including said at least one recommended menu item comprises displaying only recommended menu items.

20. The method of claim 19, wherein said displaying, on the display device, the list including said at least one recommended menu item comprises displaying only recommended menu items as user-selectable options.

21. The method of claim 16, wherein said displaying, on the display device, the list including said at least one recommended menu item comprises displaying a warning message if a selected menu item would have one of a disproportionate impact on and an incompatibility with a remaining food budget.

22. The method of claim 16, further comprising displaying, on the display device, a user-selectable element operable to place an order to purchase a selected menu item.

23. A computer program product for implementing a method of controlling a display of a computerized device, the computer program product comprising a non-transitory computer-readable medium storing executable instructions that, when executed by a processor, cause a computerized menu item recommendation device to perform a method comprising:
obtaining geolocation data for the menu item recommendation device;
identifying a list of restaurants in close proximity to the menu item recommendation device, the list comprising only restaurants having standardized menu items having standardized nutritional content;
identifying a food plan profile for a user, said food plan profile being associated with nutritional information targets;
identifying a past food consumption for a user for a particular period of time;
identifying a meal food budget for at least one food item to be consumed in a next meal, the food budget representing an available portion of a periodic food budget associated with the user's food plan profile;
displaying, on the display device, the list of restaurants;
receiving a user's selection of a restaurant;
identifying menu items and associated nutritional content information for each of a plurality of menu item of the selected restaurant;
identifying at least one recommended menu item as a function of at least one of the meal food budget, the food plan profile, and the past food consumption; and
displaying, on the display device, a list including said at least one recommended menu item.

24. The computer program product of claim 23, wherein said executable instructions cause the computerized menu item recommendation device to perform the method, the method further comprising:
identifying the list of restaurants in close proximity to the menu item recommendation device comprises identifying only restaurants having standardized menu items having standardized nutritional content.

25. The computer program product of claim 23, wherein said executable instructions cause the computerized menu item recommendation device to perform the method, the method further comprising:
identifying a food plan profile for a user comprises displaying a list of alternative food plan profiles and receiving a user's selection of input corresponding to one of said alternative food plan profiles.

26. The computer program product of claim 23, wherein said executable instructions cause the computerized menu item recommendation device to perform the method, the method further comprising:
displaying, on the display device, the list including said at least one recommended menu item comprises displaying only recommended menu items.

27. The computer program product of claim 26, wherein said executable instructions cause the computerized menu item recommendation device to perform the method, wherein the displaying, on the display device, the list including said at least one recommended menu item comprises displaying only recommended menu items as user-selectable options.

28. The computer program product of claim 23, wherein said executable instructions cause the computerized menu item recommendation device to perform the method, wherein the displaying, on the display device, the list including said at least one recommended menu item comprises displaying a warning message if a selected menu item would have one of a disproportionate impact on and an incompatibility with a remaining food budget.

29. The computer program product of claim 23, wherein said executable instructions cause the computerized menu item recommendation device to perform the method, the method further comprising:
displaying, on the display device, a user-selectable element operable to place an order to purchase a selected menu item.
